(19) United States
(12) Patent Application Publication
(10) Pub. No.: US 2003/0146806 A1
(43) Pub. Date: Aug. 7, 2003

(54) Phase shifters and arrangement consisting of several phase shifters

(76) Inventors: Peter Nuecther, Ulm (DE); Dieter Pilz, Ulm (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/220,142

(22) PCT Filed: Feb. 26, 2001
(86) PCT No.: PCT/EP01/02130

(51) Int. Cl. H01P 1/18

(52) U.S. Cl. 333/156; 333/161

(57) ABSTRACT

The invention relates to phase shifters, especially for millimeter wave applications, which are configured in form of a micromechanical switch and whose insulation layer thickness (d) is selected depending on the connected, desired phase shift φ. The thickness (d) preferably selected according to the ration (I) or according to the ration (II). The invention also relates to arrangements consisting of several of these phase shifters which can be controlled simultaneously through a common signal line and a common coplanar line.

### BACKGROUND OF THE INVENTION

A plurality of analog phase shifters are known which are controlled by means of an applied voltage. Such circuits typically contain varactor diodes, adjustable ferroelectrics or ferromagnetics. Furthermore, digital phase shifters are known in the case of which the phase range to be adjusted is divided into 2^{N} conditions by means of N digital phase shifters. These digital phase shifters are typically implemented by lines of different lengths, between which switch-over operations take place in a digitally controlled manner.

A micromechanical switch is known from U.S. Pat. No. 5,526,172, in the case of which, by the application of a control voltage, a bridge line is moved by way of a control line in the direction of a mid-wire until an electric contact is closed and the switching operation is thereby concluded. Such micromechanical switches are produced by means of known chip manufacturing technologies corresponding to resistances, capacitances and line structures in chips.

It is an object of the invention to provide phase shifters or arrangements thereof which are as small as possible, reasonable with respect to cost and easily producible.

This object is achieved by providing a phase shifter characterized in that it is constructed as a micromechanical switch and its thickness d of the insulation layer is selected as a function of the switched phase shift φ, characterized in that as well as by arrangements with several phase shifters having the characteristics wherein (1) recesses are arranged in the manner of a chessboard in the insulation layer, while being mutually separated by webs, and/or (2) several phase shifters are jointly controllable by way of a common signal line and at least one common grounding conductor, which is particularly constructed as a co-planar line, bridge lines being connected with the grounding conductor.

Advantageous further developments are contained in the subclaims.

The phase shifter according to the invention, which is particularly suitable for high-frequency applications, particularly for millimetric wave applications, for example, for the implementation of electronically steerable radar antennas, shows an arrangement consisting of a bridge line, the signal conductor and an insulation layer, which is arranged in-between and has a large defined thickness, which leads to a construction of the micromechanical switch in the manner of a two-plate capacitor. In this case, the thickness of the insulating layer, which consists of a dielectric, is selected such that a defined phase shift φ of the transmission factor exists between the switched condition of the micromechanical constructed phase shifter and the unswitched condition. By means of this micromechanical phase shifter, it is now possible to activate or to deactivate a defined and invariable phase shift. In this case, the micromechanical phase shifter was found to be very small in its dimensions and very reasonable in cost because of the chip technology used for the manufacturing. This type of a micromechanical phase shifter is particularly suitable for electronically steerable phased-array antennas, which have a plurality of T/R modules to which, in each case, one or several switched phase shifters are assigned. Because of the small size and the low energy consumption of the micromechanical phase shifters, it is possible to arrange these in, or on, the T/R modules and thereby shorten the connection lines from the phase shifters to the T/R modules. This reduces the susceptibility of the transmission of high-frequency signals. small deviations of the thickness of the insulation layer from the ideal thickness also result in significant advantages of these micromechanical phase shifters.

The micromechanical phase shifter exhibits the following functional construction.

If, in addition to the weak HF signals, a stronger direct voltage is applied between the signal line and the ground connection, which is constructed as a flexible bridge line, power acting upon the bridge line is proportional to the square of the applied voltage. Starting from a certain voltage, this power will be so high that it deflects the flexible bridge line in the center and the bridge line comes to rest on the insulation layer over the signal line, also called a mid-wire. A capacitor arrangement occurs between the signal line and the bridge line. The capacitance of the two-plate capacitor is determined by the width of the signal line, the width of the bridge, the height of the insulation layer, and the effective relative permittivity of the insulation layer, which is the result of the relative permittivity of the insulation material and the type of structuring of the insulation material and/or of the bridge. The connected capacitance causes a phase change of the transmission factor of the signal line. In order to implement small phase changes, it is sufficient to provide a single micromechanical phase shifter with correspondingly defined dimensions. It was found to be particularly advantageous to select the thickness of the insulation layer of the micromechanical phase shifter corresponding to the following formula:

$$d = \vert {ϵ}_{0} * {ϵ}_{eff} * \frac{π * f * {Z}_{0} * A}{tan ( - Φ )} \vert$$

wherein

d is the thickness of the insulation layer,

ε₀ is the electric field constant

ε_{eff} is the effective relative permittivity

A is the surface of the two-plate capacitor

Z₀ is the transverse electromagnetic wave resistance

f is the frequency of the high-frequency signal, and

φ is the desired phase difference between the two conditions.

For implementing, according to this determined relationship, a phase shifter with a with a phase difference of 11.25° at a transverse electromagnetic wave resistance of 50 Ω, at a frequency of 35 GHz, a surface A of 2,000 μm² and an effective relative permittivity of 4.8, according to the determined relationship, a required thickness of the insulation layer of 2.34 μm is obtained. When such a micromechanical switch is implemented by means of conventional chip manufacturing processes, a very small, high-quality phase shifter is obtained which is produced in a cost-effective manner.

When a negative phase shift is to be implemented, this is achieved by means of an inverse use of the switched and of the unswitched condition.

When a higher quality, and, respectively, more precise phase shift is to be achieved, it was found to be particularly advantageous to select the thickness of the dielectric according to the following relationship:

$$d = \vert - \frac{{d}_{A} {ϵ}_{eff}}{2} + \sqrt{{( \frac{{d}_{A} {ϵ}_{eff}}{2} )}^{2} + ( \frac{π * f * {Z}_{0} * {ϵ}_{0} * {ϵ}_{eff}^{2} * A * {d}_{A}}{tan ( - Φ )}} ) \vert ,$$

wherein, corresponding to the previously illustrated relationship, additionally, d_{A} is selected as the distance of the bridge line from the insulation layer in the unswitched condition. In the case of the above-described mathematical example, at a distance of the bridge line from the insulation layer d_{A}=3μm, this results in a thickness of the insulation layer of 2.1 μm. The described relationship results in a higher precision between the desired phase relationship and the thickness of the insulation layer. If very precise phase shifters are to be implemented for special applications, it was found to be advantageous to use the latter relationship, in which case it is necessary to know the distance of the bridge line from the insulation layer very precisely. This was found to be very difficult because this distance is considerably influenced by the quality of the manufacturing process of the micromechanical phase shifter.

The insulation layer is preferably structured so that it preferably has areas without a dielectric, whereby the relative permittivity of the flatly constructed insulation layer is lowered to an effective relative permittivity. Corresponding to the construction of the structuring, for example, by means of recesses which are preferably arranged in a chessboard-type manner, the effectively relative permittivity can be determined very precisely. As a result, it is possible to select the desired phase shift very precisely in small phase steps. As an alternative or in addition, it is also possible to provide the signal line or the bridge line with a corresponding structuring. This is found to be less advantageous with respect to the manufacturing quality and the defined deflection of the flexible bridge line. In addition, the structure change for adapting the phase shift can also be implemented by an adaptation of the capacitor surface.

According to another preferred embodiment of the invention, several phase shifters are combined to form a joint arrangement. The phase shifters together are acted upon by a direct voltage so that their flexible bridge lines are isochronously lowered onto the insulation layer and are, therefore, switched-on jointly as a micromechanical phase shifter. As a result, it is ensured that, by the switching-together of several identical or essentially identical micromechanical phase shifters in one arrangement in a series or parallel connection, different phase changes can be implemented without having to implement individual different micromechanical phase shifters. Solely by the different arrangement of varying numbers of identical micromechanical phase shifters or of micromechanical phase shifters reduced to a few standard types of a different thickness and/or structuring of the dielectric, of the bridge line or of the signal line, it will be possible to implement large areas of phase shifts in a simple and reliable manner. As a result of the joint controllability of some or all micromechanical phase shifters of an arrangement, it is possible to implement determined phase shifts at defined points in time, which is particularly important, especially for the controlling phase-controlled electronic steerable antennas.

The phase shifters are preferably arranged at a distance of λ/4 behind one another so that the reflection of the high-frequency signal caused by the changed capacitance can be completely reduced. At small deviations of λ/4, an extensive reduction takes place which shows a satisfactory result.

When large phase angles are to be implemented, it was found to be advantageous to use, in addition to the micromechanical phase shifters according to the invention, which exhibit the function of one phase shifter, also their effect as a micromechanical switch in order to integrate additional detour lines, which also have an effect as phase shifters, into the high-frequency signal path and, as a result, implement defined large phase shifts of up to 360°.

### BRIEF DESCRIPTION OF THE DRAWINGS

In the following, the invention will be explained in detail by means of embodiments illustrated in the figures.

FIG. 1 is a view of the phase shifter according to the invention in the unswitched condition;

FIG. 2 is a view of the phase shifter according to the invention in the switched condition;

FIG. 3 is a top view of the phase shifter;

FIG. 4 is a view of a structure of the insulation layer for influencing the effective relative permittivity; and

FIG. 5 is a view of an arrangement of several phase shifters.

### DETAILED DESCRIPTION OF THE DRAWINGS

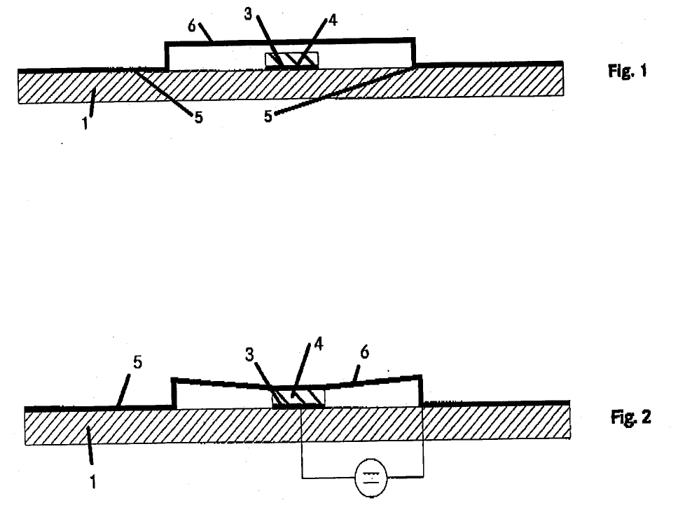

FIG. 1 illustrates a phase shifter 1 according to the invention in the unswitched condition. In its essential features, the construction of this phase shifter 1 corresponds to that of a micromechanical switch. The phase shifter 1 is arranged on a substrate 2. A signal conductor 3 is applied to the substrate 2, to which signal conductor 3 an insulation layer 4 of a defined thickness d is, in turn, applied. Parallel to the signal conductor 3, grounding conductors, here constructed as co-planar lines 5, are mounted in a spaced manner on the substrate 2, which co-planar lines 5 are connected with one another by way of a bridge line 6. The bridge line 6 is constructed as a flexible membrane. The membrane extends at a distance from the insulation layer 4 above the latter.

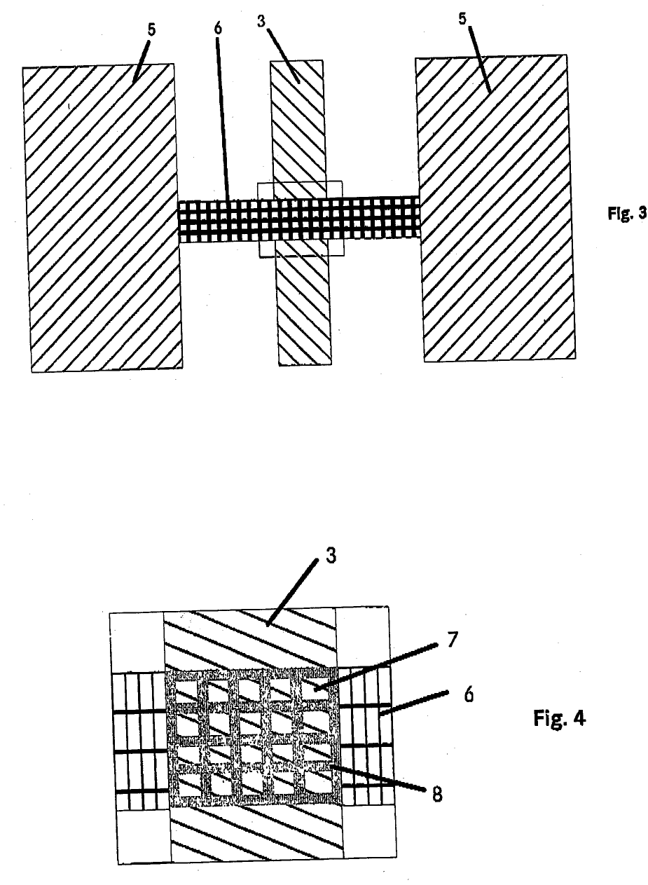

The high-frequency signals, which typically represent millimeter wave signals, are conducted by way of the signal conductor 3. When the phase shifter 1 is to be activated, the signal line is tensioned with respect to the co-planar line 5 so that, as a result of the tension difference, a force is generated upon the flexible bridge line 6 which moves the bridge line 6 in the direction of the insulation layer 4 until the bridge line 6 comes to rest on the insulation layer 4. This condition is illustrated in FIG. 2. As a result of the appropriate selection of the thickness d of the insulation layer 4, a defined phase shift φ occurs on the signal conductor 3 for the high-frequency signals transmitted to the latter. When the applied direct voltage between the signal conductor 3 and the co-planar line 5 is discontinued, the phase shifter 1 will return to the condition according to FIG. 1 and the switched-on activated phase displacement is discontinued. The described phase shifter 1 represents a phase shifter activated by micromechanics, also called a micromechanical phase shifter. It is very small; can be implemented with additional electronic components in a chip; and can be implemented in adequate piece numbers at very reasonable cost and in a high-quality manner.

FIG. 3 is a top view of the phase shifters 1 from FIG. 1 or 2. Here, the signal line 3 is arranged between two parallel extending co-planar lines 5 in a spaced and mutually electrically insulated manner. The two co-planar lines 5 are connected by way of a bridge line 6. The bridge line 6 spans the signal line 3 at a distance and has a flexible construction. Preferably, the two co-planar lines shown as examples are grounded for presenting the voltage required for the switching of the phase shifter, while a direct-voltage signal is superimposed on the signal line, in addition to the high-frequency signal. By means of the flatly constructed co-planar lines 5, a very effective mass and a very effective shielding of the signal line against EMC (electromagnetic compatibility) interferences is ensured.

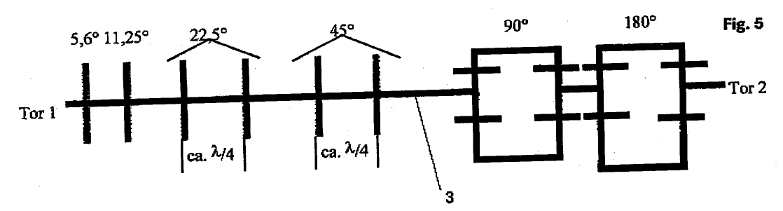

FIG. 4 illustrates an example of a structured construction of the insulation layer 4. It shows a number of rectangular recesses 7 which are distributed in a chessboard-type manner over the surface of the insulation layer 4. The recesses 7 are separated from one another by webs 8 made of the material of the insulation layer 4. As a result of this structured construction of the insulation layer, it is possible to implement an effective relative permittivity which is essentially determined by the ratio of the recesses area 7 to the insulation layer area 4. Because of the fact that the recesses 7 or the structuring of the insulation layer 4 are highly precise based on the chip manufacturing process that is used , it is possible to adjust the effective relative permittivity very precisely so that it is also possible to define, in addition to the thickness d of the insulation layer 4, also the effective relative permittivity ε_{eff} in order to implement a phase shift which is selected in a defined manner.

FIG. 5 illustrates an arrangement of several phase shifters, in which case the signal line 3 extends from gate 1 to gate 2 and the phase shifters are outlined by the bridge lines 6 arranged transversely to the signal line 3. In the arrangement according to FIG. 5, phase shifters are illustrated which have different phase angles. The first phase shifter has a switchable phase angle of 5.6°; the second of 11.25°.

The arrangement of the jointly switched third and fourth phase shifter jointly implements a phase displacement of 22.5°. For reducing the reflection effect, these phase shifters are arranged at a distance of λ/4. Correspondingly, the fifth and sixth phase shifter of an arrangement are arranged at a switchable phase angle of 45°.

In this case, the different phase angles are, on the one hand, defined by the differently selected thickness of the insulation layer and/or by an adapted structure of the insulation layer and/or the bridge line and/or the signal line. As a result (change of the width and/or length ratios of the signal line or of the bridge line or of the insulation layer), the surface of the two-plate capacitor or its relative permittivity is varied.

In this case, the third and fourth phase shifter are jointly and therefore also isochronously switched by a joint control by way of being jointly acted upon by the control voltage, so that the phase shift rises here from zero to 22.5°. Correspondingly, this is also implemented in other arrangements consisting of several joint micromechanical phase shifters.

If even higher phase angles are implemented by the combination of phase shifters and corresponding detour lines of different lengths. Partial arrangements of this type are illustrated on the right-hand side of FIG. 5.

9. (New) A phase shifter for millimeter wave applications, comprising:
a micromechanical switch having an insulation layer with a thickness d; and
wherein the thickness d of the insulation layer is selected as a function of a switched-phase shift φ.

10. (New) The phase shifter according to claim 9, wherein in a switched and in an unswitched condition, the phase shifter is guided in a transmission state.

11. (New) The phase shifter according to claim 9, wherein the thickness d is selected according to the following relationship:
$$d = \vert {ϵ}_{0} * {ϵ}_{eff} * \frac{π * f * {Z}_{0} * A}{tan ( - Φ )} \vert .$$

12. (New) The phase shifter according to claim 10, wherein the thickness d is selected according to the following relationship:
$$d = \vert {ϵ}_{0} * {ϵ}_{eff} * \frac{π * f * {Z}_{0} * A}{tan ( - Φ )} \vert .$$

13. (New) The phase shifter according to claim 9, wherein the thickness d is selected according to the following relationship:
$$d = \vert - \frac{{d}_{A} {ϵ}_{eff}}{2} + \sqrt{{( \frac{{d}_{A} {ϵ}_{eff}}{2} )}^{2} + ( \frac{π * f * {Z}_{0} * {ϵ}_{0} * {ϵ}_{eff}^{2} * A * {d}_{A}}{tan ( - Φ )} )} \vert .$$

14. (New) The phase shifter according to claim 10, wherein the thickness d selected according to the following relationship:
$$d = \vert - \frac{{d}_{A} {ϵ}_{eff}}{2} + \sqrt{{( \frac{{d}_{A} {ϵ}_{eff}}{2} )}^{2} + ( \frac{π * f * {Z}_{0} * {ϵ}_{0} * {ϵ}_{eff}^{2} * A * {d}_{A}}{tan ( - Φ )} )} \vert .$$

15. (New) The phase shifter according to claim 9, wherein the insulation layer is flat and includes recesses by which an effective relative permittivity ε_{eff} of the insulation layer is defined.

16. (New) The phase shifter according to claim 10, wherein the insulation layer is flat and includes recesses by which an effective relative permittivity ε_{eff} of the insulation layer is defined.

17. (New) The phase shifter according to claim 11, wherein the insulation layer is flat and includes recesses by which an effective relative permittivity ε_{eff} of the insulation layer is defined.

18. (New) The phase shifter according to claim 13, wherein the insulation layer is flat and includes recesses by which an effective relative permittivity ε_{eff} of the insulation layer is defined.

19. (New) The phase shifter according to claim 15, wherein the recesses are arranged in a chessboard manner in the insulation layer while being mutually separated by webs.

20. (New) An arrangement for millimeter wave applications, comprising:
a plurality of phase shifters, each being constructed as a micromechanical switch having an insulation layer with a thickness d selected as a function of a switched-phase shift φ; and
wherein the plurality of phase shifters are jointly controllable by way of a common signal line and at least one common ground conductor, the ground conductor being constructed as a co-planar line, and wherein bridge lines of the phase shifters are connected with the ground conductor.

21. The arrangement according to claim 20, wherein at least some of the plurality of the shifters are arranged in series at a distance of approximately λ/4.
